(19) United States
(12) Patent Application Publication
(10) Pub. No.: US 2026/0062597 A1
(43) Pub. Date: Mar. 5, 2026

(54) METHOD AND COMPOSITION FOR ANTI-SLIPPING, AND METHOD OF MAKING THEREOF

(71) Applicants: MOREHOUSE SCHOOL OF MEDICINE, Atlanta, GA (US); DEVMAR PRODUCTS, LLC, Nashville, TN (US)

(72) Inventors: Rick L. CHRISTIAN, Crossville, TN (US); James W. LILLARD, JR., Smyrna, GA (US); Sharon W. REYNOLDS, Brentwood, TN (US)

(21) Appl. No.: 19/384,305

(22) Filed: Nov. 10, 2025

Related U.S. Application Data
(62) Division of application No. 18/311,448, filed on May 3, 2023.

(51) Int. Cl. C09K 3/14; C09D 5/18

(52) U.S. Cl. CPC C09K 3/149; C09D 5/18

(57) ABSTRACT

A method for formulating a liquid loading and coating composition for anti-slipping that contains the step of coating a superheated granular absorbent material with a coating agent to produce a coated absorbent material and mixing the coated absorbent material with an absorbable agent, wherein the coated absorbent material absorbs the absorbable agent to form the liquid loading and coating composition. Liquid loading and coating compositions that can absorb liquids in many applications, including fire retardant, are also disclosed.

This application is a Divisional of U.S. application Ser. No. 18/311,448, filed May 3, 2023. The entirety of the aforementioned application is incorporated herein by reference

### FIELD

The present application generally relates to liquid loading and coating compositions and methods and, in particular, relates to a liquid loading and coating composition and method for anti-slipping.

### BACKGROUND

Typically, different types of agents have been utilized as flame retardants, or anti-slipping agents, in a variety of industries, including the agricultural and food preparation industries, for some time. There is a need for agents that effectuate a safer, more cost effective and/or convenient means of eliminating potentially harmful germs, viruses, funguses and bacteria. However, the inherent strength of the certain agents has at times resulted in effectiveness and cost outweighing safety. Consequently, great care must be taken by the user regarding the nature of the use of an agent. There are stringent guidelines placed on all such publicly available compositions.

There are several dry cleaning methods that have been introduced to the market. They all are applied over the stain and left to work. They are time driven (often claiming that microbes will consume the oil). Many companies have tried these and continue in some cases to use them because there is no alternative. Amongst other problems are: 1) the powder is not picked up after applying and according to the EPA you are introducing more contaminates to the environment; 2) the powder tracks into facilities and consumer's cars; 3) it merely covers-up the stain; 4) residue can burn employee's wet skin due to alkalinity; and 5) most are basically a Portland cement mixture that can potentially mark good cement and bring unwanted silt to oil water separators.

Therefore, a liquid loading and coating composition that can be used for a variety of purposes, including fire retardation, or anti-slipping is highly desirable.

### SUMMARY

An aspect of the application is a method of formulating a liquid loading and coating composition for anti-slipping, comprising the steps of: coating a granular absorbent material with a coating agent to produce a coated absorbent material, wherein the coating agent is cleared silane or siloxane water repellant; wherein the coating agent forms a surface bonded film on the granular absorbent material, and wherein the granular absorbent material is selected from the group consisting of ceramic minerals, perlite, zeolite, activated carbon, fumed silica, processed clays, cellulosic absorbents, fibrous absorbents and combinations thereof, and superheating and continued mixing of the granular absorbent material with the coating agent to form a coated absorbent material; mixing the coated absorbent material with an absorbable agent, wherein the absorbable agent is rapeseed oil; wherein the coated absorbent material absorbs the absorbable agent to form the composition, wherein the absorbable agent is a liquid.

Another aspect of the application is a method for anti-slipping, comprising the steps of: applying in powder form to an exposed surface an effective amount of a liquid loading and coating composition comprising: a granular absorbent material coated with a coating agent, wherein the coating agent forms a surface bonded film on the granular absorbent material, wherein the coating agent is cleared silane or siloxane water repellant, and wherein the granular absorbent material is selected from one of the group consisting of ceramic minerals, perlite, zeolite, activated carbon, fumed silica, processed clays, cellulosic absorbents, fibrous absorbents and combinations thereof, wherein the granular absorbent agent has been super-heated; and an absorbable agent absorbed in said granular absorbent material.

Another aspect of the application is a method for flame retardation, comprising the steps of: applying in powder form to an exposed flame an effective amount of a liquid loading and coating composition comprising: a granular absorbent material coated with a coating agent, wherein the coating agent forms a surface bonded film on the granular absorbent material, wherein the coating agent is selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof, and wherein the granular absorbent material is selected from the group consisting of ceramic minerals, perlite, zeolite, activated carbon, fumed silica, processed clays, cellulosic absorbents, fibrous absorbents and combinations thereof, and an absorbable agent absorbed in said granular absorbent material, wherein the absorbable agent is selected from one or more of the group consisting of surfactants, anionic surfactants, inorganic salts, ferrocene and fluorinated surfactants, and combinations thereof.

A liquid loading and coating composition for anti-slipping, comprising: a granular absorbent material coated with a coating agent, wherein the coating agent forms a surface bonded film on the granular absorbent material, wherein the coating agent is cleared silane or siloxane water repellant, and wherein the granular absorbent material is selected from one of the group consisting of ceramic minerals, perlite, zeolite, activated carbon, fumed silica, processed clays, cellulosic absorbents, fibrous absorbents and combinations thereof, wherein the granular absorbent agent has been super-heated; and an absorbable agent absorbed in said granular absorbent material.

A liquid loading and coating composition for flame retardation, comprising: a granular absorbent material coated with a coating agent, wherein the coating agent forms a surface bonded film on the granular absorbent material, wherein the coating agent is selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof, and wherein the granular absorbent material is selected from the group consisting of ceramic minerals, perlite, zeolite, activated carbon, fumed silica, processed clays, cellulosic absorbents, fibrous absorbents and combinations thereof, and an absorbable agent absorbed in said granular absorbent material, wherein the absorbable agent is selected from one or more of the group consisting of surfactants, including anionic surfactants, as well as inorganic salts and/or ferrocene in combination with anionic surfactants, and fluorinated surfactants and combinations thereof.

These and other aspects and embodiments of the present application will become better understood with reference to the following detailed description when considered in association with the accompanying drawings and claims.

### BRIEF DESCRIPTION OF DRAWINGS

The figures herein are illustrative of non-limiting embodiments of the invention.

FIG. 1 illustrates the four stages in making an anti-slipping agent as described in certain embodiments herein.

FIG. 2 shows the stages of the anti-slipping agent in action in a certain embodiment. (1) a spill is made on a surface which includes both water and grease (black circles); (2) the anti-slipping agent as described herein is applied (square boxes); (3) the anti-slipping agent absorbs the grease, but not the water due to its hydrophobic properties, the spill is cleaned up by a sweep (represented by horizontal arrow); and (4) the surface has friction restored and is now safe for standing on.

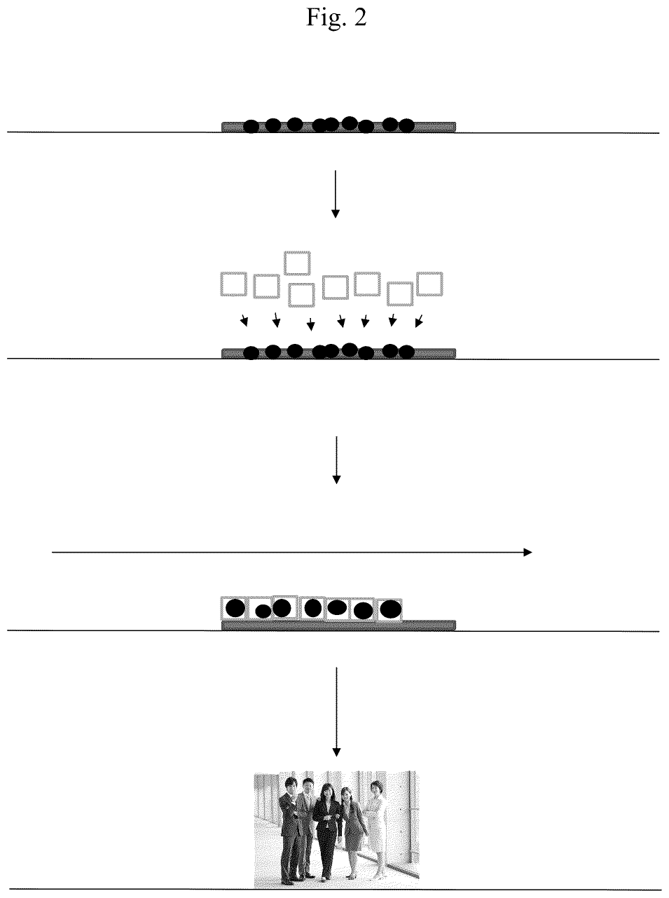

### DETAILED DESCRIPTION OF THE INVENTION

The aspects of the application are described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it is understood that the particular value forms another embodiment. It is further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed.

This application describes a novel, effective and low cost liquid loading and coating composition that can be used for a variety of purposes, such as fire retardation, anti-slipping in hospitals, urgent care facilities, medical offices, nursing homes, prisons, schools, farms and the hospitality industry. This method and formulation is also ideally suited for common, highly hazardous spills in these environments, e.g., spills of oil or grease.

As used herein, the term “fire retardant or anti-slipping agent” refers to any materials that may have functions that destroys, inactivates, eliminates, deters, inhibits the growth of, or otherwise, alternately or separately or together, retards flame, produces anti-slipping. Some agents may be both fire retardants and anti-slipping agents, etc. Examples of fire retardant or anti-slipping agent includes, but are not limited to, those listed herein.

### Method of Making

One aspect of the present application is directed to a method of making a liquid loading and coating composition. The method comprises the steps of coating a granular absorbent material with a coating agent to produce a coated absorbent material; and mixing the coated absorbent material with a fire retardant or anti-slipping agent, wherein the coated absorbent material absorbs the fire retardant or anti-slipping agent to form a coated and absorbed absorbent material. In some embodiments, the method further comprises the step of grinding an absorbent material to produce the granular absorbent material used in the coating step. In other embodiments, the method further comprises the step of adding one or more modifying agent to the coated and absorbed absorbent material in amounts sufficient to achieve desired physical characteristics (e.g., non-dusty and clump, ease of pick up, loading and coating capacity, etc.).

The liquid loading and coating composition may be used for a variety of purposes, such as to eradicate, eliminate, inactivate, inhibit the activity of, or reduce the amount of pathogens on a surface. The liquid loading and coating composition may be used for anti-slipping or fire retardant in hospitals, urgent care facilities, medical offices, nursing homes, prisons, schools, farms and the hospitality industry. The liquid loading and coating composition of the present application is also ideally suited for clean-up of common, highly hazardous spills in these environments, such as spills of oil or grease.

### The Granular Absorbent Material

The granular absorbent material can be any solid material with desired surface area, granulation, and absorbent characteristics. As used herein, the term “absorbent” or “adsorbent” is understood to mean a material that is capable of imbibing and holding onto aqueous fluids. Suitable granular absorbent material include, but are not limited to, expanded and optimized ceramic minerals such perlite and vermiculite, zeolite, activated carbon, cellulosic absorbents and fibrous absorbents. In some embodiments, the granular absorbent material contains activated carbon, fumed silica, fine perlite, zeolites, processed clays or combinations thereof. The adsorbent/absorbent will exhibit clumping or matting characteristics for best performance and be well de-dusted. The granular absorbent material preferably has a surface area per mass or volume ratio. In some embodiments, the granular absorbent material has a surface area per mass ratio in the range of 100-10,000 m²/g, 100-9,000 m m²/g, 100-8,000 m²/g, 300-8,000 m²/g, 1,000-8,000 m²/g, 2,000-8,000 m²/g, 3,000-8,000 m²/g, 4,000-8,000 m²/g, 5,000-8,000 m²/g, 6,000-8,000 m²/g, 7,000-8,000 m²/g, 100-7,000 m²/g, 300-7,000 m²/g, 1,000-7,000 m²/g, 2,000-7,000 m²/g, 3,000-7,000 m²/g, 4,000-7,000 m²/g, 5,000-7,000 m²/g, 6,000-7,000 m²/g, 100-6,000 m²/g, 300-6,000 m²/g, 1,000-6,000 m²/g, 2,000-6,000 m²/g, 3,000-6,000 m²/g, 4,000-6,000 m²/g, 5,000-6,000 m²/g, 100-4,000 m²/g, 300-4,000 m²/g, 1,000-4,000 m²/g, 2,000-4,000 m²/g, 3,000-4,000 m²/g, 100-3,000 m²/g, 300-3,000 m²/g, 1,000-3,000 m²/g, 2,000-3,000 m²/g, 100-2,000 m²/g, 300-2,000 m²/g, or 1,000-2,000 m²/g.

In some embodiments, the granular absorbent material has a surface area per mass ratio up to 10,000 m²/g. In some embodiments, the granular absorbent material has a surface area per mass ratio up to 9,000 m²/g. In some embodiments, the granular absorbent material has a surface area per mass ratio up to 8,000 m²/g. In some embodiments, the granular absorbent material has a surface area per mass ratio up to 7,000 m²/g. In some embodiments, the granular absorbent material has a surface area per mass ratio up to 6,000 m²/g.

In some embodiments, the granular absorbent material has a surface area per mass ratio of 100 m²/g or greater. In some embodiments, the granular absorbent material has a surface area per mass ratio of 300 m²/g or greater. In some embodiments, the granular absorbent material has a surface area per mass ratio of 1,000 m²/g or greater. In some embodiments, the granular absorbent material has a surface area per mass ratio of 2,000 m²/g or greater. In some embodiments, the granular absorbent material has a surface area per mass ratio of 3,000 m²/g or greater. In some embodiments, the granular absorbent material has a surface area per mass ratio of 4,000 m²/g or greater. In some embodiments, the granular absorbent material has a surface area per mass ratio of 5,000 m²/g or greater.

In some embodiments, the granular absorbent material has a surface area per mass ratio in the range of 1000-6,000 m²/g.

In some embodiments, the granular absorbent material contains ceramic minerals.

In some embodiments, the granular absorbent material contains perlite and/or vermiculite.

In some embodiments, the granular absorbent material has a surface area per volume ratio in the range of 100-5,000 m²/ml, 300-5,000 m²/ml, 1,000-5,000 m²/ml, 2,000-5,000 m²/ml, 3,000-5,000 m²/ml, 4,000-5,000 m²/ml, 100-4,000 m²/ml, 300-4,000 m²/ml, 1,000-4,000 m²/ml, 2,000-54,000 m²/ml, 3,000-4,000 m²/ml, 100-3,000 m²/ml, 300-3,000 m²/ml, 1,000-3,000 m²/ml, 2,000-3,000 m²/ml, 100-2,000 m²/ml, 300-2,000 m²/ml, or 1,000-2,000 m²/ml.

In some embodiments, the granular absorbent material has a surface area per volume ratio up to 5,000 m²/ml. In some embodiments, the granular absorbent material has a surface area per volume ratio up to 4,000 m²/ml. In some embodiments, the granular absorbent material has a surface area per volume ratio up to 3,000 m²/ml.

In some embodiments, the granular absorbent material has a surface area per volume ratio of 100 m²/ml or greater. In some embodiments, the granular absorbent material has a surface area per volume ratio of 300 m²/ml or greater. In some embodiments, the granular absorbent material has a surface area per volume ratio of 1,000 m²/ml or greater. In some embodiments, the granular absorbent material has a surface area per volume ratio of 2,000 m²/ml or greater. In some embodiments, the granular absorbent material has a surface area per volume ratio in the range of 1000-3,000 m² ml.

As used herein, the term “ceramics” shall mean compounds of nonmetallic elements possessing in general hardness, compressive strength, elastic modulus, thermal expansion and density. Exemplary ceramics include, but are not limited to, materials used in pottery, bricks, tiles, cements and glass, barium titanate, strontium titanate, bismuth strontium calcium copper oxide, boron oxide, boron nitride, earthenware, ferrite, lead zirconate titanate, magnesium diboride, porcelain, sialon, silicon carbodie, silicon nitride, steatite, titanium carbide, uranium oxide, yttrium barium copper oxide, zinc oxide, zirconium dioxide, and partially stabilized zirconia. Ceramics may be oxides (aluminia, beryllia, ceria, zirconia), nonoxides (carbide, boride, nitride, silicide) or composite materials (combinations of oxides and onoxides).

Perlite is a naturally occurring form of obsidian characterized by spherulites formed by cracking of volcanic glass during cooling. Perlite typically comprises a mix of silicon dioxide, aluminium oxide, sodium oxide, potassium oxide, iron oxide, magnesium oxide and calcium oxide. Potential substitutes for perlite include, but are not limited to, diatomite, expanded clay, shale, pumice, slag or vermiculite. Vermiculite is a naturally occurring hydrous phyllosilicate material, which is 2:1 clay.

As used herein, the term “zeolite” shall mean any of a large group of minerals comprising hydrated aluminosilicates of sodium, potassium, calcium and barium. Zeolite can occur naturally, but is also artificially synthesized. Exemplary zeolites include, but are not limited to, analcime, chabazite, clinoptilolite, heulandite, natrolite, phillipsite, and stilbite.

As used herein, the term “activated carbon” shall mean a form of carbon processed to have small, low-volume pores that increase the surface area available for adsorption or chemical reactions. A synonym for activate carbon is “activated charcoal.”

As used herein, the term “cellulosic absorbents” shall mean cellulose and cellulose derivatives that can provide structure, bulk, water-holding capacity and channeling of fluids over a wide dimensional range.

As used herein, the term “fibrous absorbents” refers to a fibrous structure with high void volume, a hydrophilic nature, and wet resiliency. Examples of fibrous absorbents include, but are not limited to, cotton fiber based absorbents, corn fiber based absorbents and hemp based absorbents.

In some embodiments, the granular absorbent material constitutes 10-70% (w/w), 10-60% (w/w), 10-50% (w/w), 10-40% (w/w), 10-30% (w/w), 10-20% (w/w), 20-70% (w/w), 20-60% (w/w), 20-50% (w/w), 20-40% (w/w), 20-30% (w/w), 30-70% (w/w), 30-60% (w/w), 30-50% (w/w), 30-40% (w/w), 40-70% (w/w), 40-60% (w/w), 40-50% (w/w), 50-70% (w/w), 50-70% (w/w) or 60-70% (w/w) of the final product. In some embodiments, the granular absorbent material constitutes 25-30% (w/w) of the final product. In some embodiments, the granular absorbent material constitutes about 27% (w/w) of the final product.

### Liquid-Loading and Coating

The liquid-liquid loading and coating compositions comprising granular absorbent material described herein are suitable to load a wide variety of liquids. One of ordinary skill will understand that there are many contexts in which liquid-liquid loading and coating compositions may be used to absorb liquids and the choice of any such context is not limiting on the invention. One of ordinary skill will understand that the identity of the liquid that is absorbed by the composition is also not limiting on the invention. In various non-limiting embodiments, liquid-loaded compositions can be applied in the context of absorbing oil/liquid spilled on floors, anti-slipping out tanks and vats, containing and collecting oil/liquid around equipment, preventing oil/liquid from entering drains, or collecting oil/liquid for recycling or disposal. In certain embodiments, the liquids that are captured by the absorbent may be biofluids, such as blood, urine or vomit. In other embodiments, the liquids that are absorbed may be oils, cutting fluids, coolants, solvents, or any water-based fluids. In particular embodiments, the liquids may be hydraulic oil, motor oil, brake fluid, cooking oil, turpentine or other oil-based fluids (chemotherapy drug, biofilm, decomposing waste from animal carcasses and human bodies, and odor causing waste materials).

Liquids (or substances often found in liquid form) that may be loaded (individually, combined, or in a multi-mix) on the compositions described herein may include, but are not limited to, the following: solvents (alcohol, naphtha, toluene, ketones), hydrocarbon solvents (aliphatic (e.g., hexane, mineral spirits, gasoline); aromatic solvents (e.g., benzene, toluene, xylene); naphtenic solvents (e.g., cyclohexane); chlorinated solvents (e.g. trichloroethylene, carbon tetrachloride)), oxygenated solvents (alcohols (e.g., ethanol); esters (e.g., methyl acetate, ethyl acetate), ketones (e.g., acetone)), paints (oil-base or water-base), lecithin, dimethylketone, acetone, blood, epoxy resins, glue, hot melt, morpholine, polyvinyl acetate, tetrahydrofuran, vinyl acetate, aerosols, alkyd resins, amyl acetate, amyl alcohol, butanol, butyl alcohol, calcium chloride brine, choline chloride, denatured alcohol, detergents (e.g., alkylaryl sulfonates, sulfates, fatty alcohols, fatty acids or amines), ethyl acetate, ethyl alcohol, ethylene alcohol, ethylene glycol, glycerin, isobutyl alcohol, isopropyl alcohol, kerosene, lacquer, mercaptans, methanol, methyl alcohol, methylene chloride, paraffin, perchloroethylene, polyol, polyvinyl alcohol, propylene glycol, shellac, sodium hydroxide, styrene, wood alcohol, xylene, ammonia, ammonium hydroxide, aqueous ammonia, ethanolamine, refrigerants, animal fats, aroclor, asphalt, cut-back asphalt, emulsified asphalt, bitumen, emulsion (e.g. milk, mayonnaise, egg yolk, casein, soap, bentonite, liquid petroleum emulsions, asphalt emulsions), barium sulfate slurry, beer, wax (e.g., paraffin, liquid wax, molten was, beeswax), coal tar, cottonseed oil, cresol, divinylbenzene, dodecylbenzene, lecithin, methylbenzene, phenol (e.g., phenylic acid, benzophenol, hydrobenzene), pitch (e.g., coal-tar pitch, hot pitch, tar pitch, roof pitch), sulfonic acid, heat transfer oil (e.g., biphenyl), black liquor soap, soap skimmings, molasses (e.g., beet molasses, cane molasses, black strap molasses), bright stock, brine, calcium chloride brine, sodium chloride brines, bunker C fuel oil, butadiene, polymer liquids, butane, isobutane, butter, cocoa butter, peanut butter, calcium stearate, carbolic acid, carbon disulfide, cod-liver oil, sulphur, cane syrup, carbon tetrachloride, perchloromethane, castor oil, caustic, caustic potash, caustic soda, sodium hydroxide, viscose, chlordane, chloroform, chlorothene, chocolate, choline chloride, clay coatings, cold dat, contact cement, cooking oils, grease (e.g. lubricating grease, automotive grease, bearing grease), corn oil, corn starch, creosote, cresylic acid, crude oil, dioctyl phthalate, dioktyl phthalate, heat transfer liquids (e.g., mineral oil, diphenyls, modified terphenyls, polyalkalene glycols), edible oils, enamel, linseed oil, fats (e.g., animal fat, cold fat, liquid fat, hot fat, lard, hased fat, ground fat), fatty acid, oleic acid, palmitic acid, stearic acid, soybean oil, fish oil, fish solubles, fluorocarbons (e.g., freons), formaldehyde, formalin, melamine resins, phenol-formaldehyde resins, urea formaldehyde, fruit juices (e.g., grape juice, lemon juice), fuel oil no. 1, fuel oil no. 2, fuel oil no. 3, fuel oil no. 4, fuel oil no. 5, fuel oil no. 6, fumigant, insecticides, furfural, gasoline, jet fuels, lanolin (e.g., hydrous wool fat), liquid feed (e.g., cattle feed solution, liquid cattle feed, liquid supplement), liquid stick, propane, liquefied petroleum, lye, margarine, meat emulsion, melamine resins, mercaptans, methanol, methyl alcohol, mineral oil, petrolatum, printing ink, palmitic acid, olive oil, orange juice, orthophosphoric acid, phosphoric acid, paper coating, plasticizers, sugar syrup, sausage stuffing, transformer oil, toluene diisocyanate, toluol, ucon, varnish, shellac, water, sodium silicate, whey, yeast, zinc oxide.

The liquid-liquid loading and coating composition described herein may be used to absorb liquid in environmental processes where separation of liquid and solid is desired. In other embodiments, the liquid-liquid loading and coating composition described herein may be used in many applications in which rapid liquid absorption is required, such as oil spill clean-up, moisture management systems, medical dressings and anti-slipping systems. The liquid-loading and coating systems described herein may be incorporated in microfluidic devices.

### The Coating Agent

The coating agent can be any fire retardant or anti-slipping agent capable of forming a coating layer on the surface of the granular absorbent material of the present application. In some embodiments, the coating agent contains one or more agents selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof. In some embodiments, the coating agent is one or more selected from the group comprising surfactants, anionic surfactants, inorganic salts, ferrocene and fluorinated surfactants, and combinations thereof.

In some embodiments, the coating agent is a fire retardant or anti-slipping agent that forms a surface bonded film on the granular absorbent material. The static surface bonded fire retardant or anti-slipping agent film provides a long term desired effect in contact with the liquid loading and coating composition of the present invention, thus providing a long term assurance of the effectiveness of the anti-slipping effect. In some embodiments, the coating agent is applied to the granular absorbent material by vapor deposition. In some embodiments, the vapor deposition is performed by thermal heating the coating agent and the granular absorbent.

In some embodiments, the coating agent is applied to the granular absorbent material by pressure micro droplet spray.

In some embodiments, the coating agent is applied to the granular absorbent material by a fuming or fogging nozzle.

In some embodiments, the coating agent is applied to the granular absorbent material by a deposition technique commonly used for metal plating.

In some embodiments, the coating agent is added in an amount that constitutes 0.1 to 10% (w/w), 0.1 to 5% (w/w), 0.1 to 2% (w/w), 0.1 to 1% (w/w), 0.1 to 0.5% (w/w), 0.3 to 10% (w/w), 0.3 to 5% (w/w), 0.3 to 2% (w/w), 0.3 to 1% (w/w), 1 to 10% (w/w), 1 to 5% (w/w), 1 to 2% (w/w), 3 to 10% (w/w) or 3 to 5% (w/w) of the final product.

In some embodiments, the coating agent is added in an amount that constitutes 0.5 to 3.5% (w/w) or 1 to 3% (w/w) of the final product. In some embodiments, the coating agent is added in an amount that constitutes about 2% (w/w) of the final product.

### The Fire Retardant or Anti-Slipping Agent

The fire retardant or anti-slipping agent can be any agent having the desired activity and can be absorbed by the coated granular absorbent of the present application. The fire retardant or anti-slipping agent comprise an active substance designed to suppress flame, increase surface grip to prevent slipping. In some embodiments, the fire retardant or anti-slipping agent is a liquid phase agent. In some embodiment, the fire retardant or anti-slipping agent is a liquid phase chemical that inactivates or removes toxic chemicals, such as oil. In some embodiments, the liquid phase fire retardant or anti-slipping agent is added at an application site to provide fire retardation or anti-slipping for immediate response.

In some embodiments, the fire retardant or anti-slipping agent is added in an amount that constitutes 0.1 to 10% (w/w), 0.1 to 3% (w/w), 0.1 to 1% (w/w), 0.1 to 0.3% (w/w), 0.3 to 10% (w/w), 0.3 to 3% (w/w), 0.3 to 1% (w/w), 1 to 10% (w/w), 1 to 3% (w/w) or 3 to 10% (w/w) of the final product.

In some embodiments, the fire retardant or anti-slipping agent comprises dimethyl benzyl ammonium chloride or dimethyl ethybenzyl ammonium chloride. In some embodiments, the fire retardant/anti-slipping agent comprises a mixture of dimethyl benzyl ammonium chloride or dimethyl ethybenzyl ammonium chloride. In some embodiments, the fire retardant/anti-slipping agent is a 1:1 mixture of dimethyl benzyl ammonium chloride or dimethyl ethybenzyl ammonium chloride.

In some embodiments, the fire retardant/anti-slipping agent comprises a quaternary amine and is added in an amount that constitutes 0.3 to 3% (w/w), 0.5 to 2% (w/w) or 0.5 to 1.5% (w/w) of the final product. In some embodiments, the fire retardant or anti-slipping agent is a quaternary amine and is added in an amount that constitutes about 1% (w/w) of the final product.

In certain embodiments the fire retardant/anti-slipping agent is either the coating agent, the absorbable agent, or both. In certain embodiments, the coating agent may be selected from one or more of the group consisting of surfactants, including anionic surfactants, as well as inorganic salts and/or ferrocene in combination with anionic surfactants, and fluorinated surfactants and combinations thereof. In certain embodiments, the absorbable agent is selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof. In certain embodiments, the coating agent and absorbable agent are the same.

### The Modifying Agent

The modifying agent is added to the coated granular absorbent or the absorbed-and-coated granular absorbent in an amount to achieve desired physical characteristics (e.g., non-dusty and clump, ease of pick up, liquid loadability, etc.) in the final product. Examples of the modifying agent include, but are not limited to, thickening agents, gums, absorbent polymers, tackifiers, and combinations thereof.

As used herein, the term “thickening agent” may include any material known or otherwise effective in providing suspending, gelling, viscosifying, solidifying or thickening properties to the composition or which otherwise provide structure to the final product form. These thickening agents may include gelling agents, polymeric or nonpolymeric agents, inorganic thickening agents, or viscosifying agents. The amount and type of the thickening agent may vary depending upon the desired characteristics of the final product.

As used herein, the term “tackifier” refers to polymeric adhesives which increase the tack, i.e., the inherent stickiness or self-adhesion, of the compositions so that after a short period of gentle pressure they adhere firmly to surfaces. Examples of suitable tackifiers comprise high-flexibility resins such as, but not limited to, homopolymers of alkyl(meth)acrylates, especially alkyl acrylates, such as poly(isobutyl acrylate) or poly(2-ethylhexyl acrylate), linear polyesters, as commonly used for coil coating, linear difunctional oligomers, curable with actinic radiation, with a number average molecular weight of more than 2000, in particular from 3000 to 4000, based on polycarbonatediol or polyester-diol, linear vinyl ether homopolymers or copolymers based on ethyl, propyl, isobutyl, butyl and/or 2-ethylhexyl vinyl ether, or nonreactive urethane urea oligomers, which are prepared from bis(4,4-isocyanatophenyl)methane, N,N-dimethylethanolamine or diols such as propanediol, hexanediol or dimethylpentanediol.

In some embodiments, the modifying agent comprises a high-molecular substance that absorbs liquids, preferably water, swells, and finally is converted to a viscous true or colloidal solution.

In some embodiments, the modifying agent comprises one or more silicone gums. As used herein, the term “silicone gum” means a silicone polymer having a degree of polymerization sufficient to provide a silicone having a gum-like texture. In certain cases the silicone polymer forming the gum may be crosslinked.

In some embodiments, the modifying agent comprises a polymer. As used herein, Examples of the polymers include, but is not limited to, natural and synthetic polymers such as polyacrylamide (ACAM) and carboxymethyl cellulose.

In some embodiments, the polymers of the present application includes, but are not limited to, polyacrylates such as sodium polyacrylates, and carboxymethyl cellulose.

In some embodiments, the modifying agent comprises one or more super-absorbent polymer. The term “super-absorbent polymer” is understood to mean hydrophilic polymer structure capable of absorbing water or saline solution at greater than 10 g of pure water/saline per gram of dry-based material (>10 g/g). Examples of super-absorbent polymers include, but are not limited to, sodium polyacrylates and carboxymethyl cellulose.

In some embodiments, the one or more modifying agents further comprise one or more additives selected from the group comprising denaturing agents, colorant agents, odor correctors, and/or pH regulators.

In some embodiments, the one or more modifying agents are added in an amount that constitute 0.1 to 5% (w/w), 0.1 to 2% (w/w), 0.1 to 1% (w/w), 0.1 to 0.3% (w/w), 0.3 to 5% (w/w), 0.3 to 2% (w/w), 0.3 to 1% (w/w), 1 to 5% (w/w), 1 to 2% (w/w) or 2 to 5% (w/w) of the final product.

### The Liquid Loading and Coating Composition

Another aspect of the present application relates to a liquid loading and coating composition. The liquid loading and coating composition contains a granular absorbent material coated with a coating agent. Examples of the coating agent have been described above. In some embodiments, the coating agent contains a fire retardant or anti-slipping agent. In some embodiments, the fire retardant agent comprises an agent selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604. In some embodiments, the fire retardant agent comprises one or more selected from the group consisting of surfactants, anionic surfactants, inorganic salts, ferrocene and fluorinated surfactants, and combinations thereof. In certain embodiments, the fire retardant agent may be coated or absorbed or both. In certain embodiments, the fire retardant agent may be the same agent used for coating and also as an absorbable agent. In some embodiments, the fire retardant or anti-slipping agent forms a static film on the surface of the granular absorbent material. In some embodiments, the granular absorbent material contains activated carbon, fumed silica, fine perlite, zeolites, processed clays or combinations thereof. In some embodiments, the coating agent constitutes 0.1 to 5% (w/w), 0.1 to 2% (w/w), 0.1 to 1% (w/w), 0.1 to 0.3% (w/w), 0.3 to 5% (w/w), 0.3 to 2% (w/w), 0.3 to 1% (w/w), 1 to 5% (w/w), 1 to 2% (w/w) or 2 to 5% (w/w) of the liquid loading and coating composition.

In some embodiments, the granular absorbent material contains ceramic minerals. In some embodiments, the granular absorbent material contains perlite and/or vermiculite. In some embodiments, the granular absorbent material has a surface area per mass ratio in the range of 100-10,000 m²/g, 100-9,000 m²/g, 100-8,000 m²/g, 300-8,000 m²/g, 1,000-8,000 m²/g, 2,000-8,000 m²/g, 3,000-8,000 m²/g, 4,000-8,000 m²/g, 5,000-8,000 m²/g, 6,000-8,000 m²/g, 7,000-8,000 m²/g, 100-7,000 m²/g, 300-7,000 m²/g, 1,000-7,000 m²/g, 2,000-7,000 m²/g, 3,000-7,000 m²/g, 4,000-7,000 m²/g, 5,000-7,000 m²/g, 6,000-7,000 m²/g, 100-6,000 m²/g, 300-6,000 m²/g, 1,000-6,000 m²/g, 2,000-6,000 m²/g, 3,000-6,000 m²/g, 4,000-6,000 m²/g, 5,000-6,000 m²/g, 100-4,000 m²/g, 300-4,000 m²/g, 1,000-4,000 m²/g, 2,000-4,000 m²/g, 3,000-4,000 m²/g, 100-3,000 m²/g, 300-3,000 m²/g, 1,000-3,000 m²/g, 2,000-3,000 m²/g, 100-2,000 m²/g, 300-2,000 m²/g, or 1,000-2,000 m²/g.

In some embodiments, the granular absorbent material has a surface area per mass ratio up to 10,000 m²/g. In some embodiments, the granular absorbent material has a surface area per mass ratio up to 9,000 m²/g. In some embodiments, the granular absorbent material has a surface area per mass ratio up to 8,000 m²/g. In some embodiments, the granular absorbent material has a surface area per mass ratio up to 7,000 m²/g. In some embodiments, the granular absorbent material has a surface area per mass ratio up to 6,000 m²/g.

In some embodiments, the granular absorbent material has a surface area per mass ratio of 100 m²/g or greater. In some embodiments, the granular absorbent material has a surface area per mass ratio of 300 m²/g or greater. In some embodiments, the granular absorbent material has a surface area per mass ratio of 1,000 m²/g or greater. In some embodiments, the granular absorbent material has a surface area per mass ratio of 2,000 m²/g or greater. In some embodiments, the granular absorbent material has a surface area per mass ratio of 3,000 m²/g or greater. In some embodiments, the granular absorbent material has a surface area per mass ratio of 4,000 m²/g or greater. In some embodiments, the granular absorbent material has a surface area per mass ratio of 5,000 m²/g or greater.

In some embodiments, the granular absorbent material has a surface area per mass ratio in the range of 1000-6,000 m²/g.

In some embodiments, the granular absorbent material has a surface area per volume ratio in the range of 100-5,000 m²/ml, 300-5,000 m²/ml, 1,000-5,000 m²/ml, 2,000-5,000 m²/ml, 3,000-5,000 m²/ml, 4,000-5,000 m²/ml, 100-4,000 m²/ml, 300-4,000 m²/ml, 1,000-4,000 m²/ml, 2,000-54,000 m²/ml, 3,000-4,000 m²/ml, 100-3,000 m²/ml, 300-3,000 m²/ml, 1,000-3,000 m²/ml, 2,000-3,000 m²/ml, 100-2,000 m²/ml, 300-2,000 m²/ml, or 1,000-2,000 m²/ml.

In some embodiments, the granular absorbent material has a surface area per volume ratio up to 5,000 m²/ml. In some embodiments, the granular absorbent material has a surface area per volume ratio up to 4,000 m²/ml. In some embodiments, the granular absorbent material has a surface area per volume ratio up to 3,000 m²/ml.

In some embodiments, the granular absorbent material has a surface area per volume ratio of 100 m²/ml or greater. In some embodiments, the granular absorbent material has a surface area per volume ratio of 300 m²/ml or greater. In some embodiments, the granular absorbent material has a surface area per volume ratio of 1,000 m²/ml or greater. In some embodiments, the granular absorbent material has a surface area per volume ratio of 2,000 m²/ml or greater. In some embodiments, the granular absorbent material has a surface area per volume ratio in the range of 1000-3,000 m²/ml.

In some embodiments, the granular absorbent material constitutes 10-70% (w/w), 10-60% (w/w), 10-50% (w/w), 10-40% (w/w), 10-30% (w/w), 10-20% (w/w), 20-70% (w/w), 20-60% (w/w), 20-50% (w/w), 20-40% (w/w), 20-30% (w/w), 30-70% (w/w), 30-60% (w/w), 30-50% (w/w), 30-40% (w/w), 40-70% (w/w), 40-60% (w/w), 40-50% (w/w), 50-70% (w/w), 50-70% (w/w) or 60-70% (w/w) of the liquid loading and coating composition. In some embodiments, the granular absorbent material constitutes 25-30% (w/w) of the final product. In some embodiments, the granular absorbent material constitutes about 27% (w/w) of the liquid loading and coating composition.

In some embodiments, the liquid loading and coating composition further comprises a fire retardant or anti-slipping agent absorbed in the coated granular absorbent material. Examples of the fire retardant or anti-slipping agent have been described herein.

In some embodiments, the fire retardant or anti-slipping agent comprise an active substance designed to destroy, inhibit, reduce activity, inhibit grow or otherwise render harmless toxic chemicals. In some embodiments, the fire retardant or anti-slipping agent is a liquid phase agent. In some embodiments, the fire retardant or anti-slipping agent is a liquid phase fire retardant or anti-slipping agent. In some embodiment, the fire retardant or anti-slipping agent is a liquid phase chemical that inactivates toxic chemicals.

Examples of liquid phase fire retardant agent include, but are not limited to, Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and mixtures thereof.

Examples of liquid phase chemicals that can be used to inactivate or remove toxic chemicals include, but are not limited to, anionic surfactants such as soap, sulfonates and sulfates. In some embodiments, large quantities of water is used to dilute the toxic chemicals.

In some embodiments, the fire retardant or anti-slipping agent constitutes 0.1 to 10% (w/w), 0.1 to 30% (w/w), 0.1 to 10% (w/w), 0.1 to 0.30% (w/w), 0.3 to 10% (w/w), 0.3 to 30% (w/w), 0.3 to 1% (w/w), 1 to 10% (w/w), 1 to 3% (w/w) or 3 to 10% (w/w) of the liquid loading and coating composition.

In some embodiments, the fire retardant or anti-slipping agent comprises dimethyl benzyl ammonium chloride or dimethyl ethybenzyl ammonium chloride. In some embodiments, the fire retardant or anti-slipping agent comprises a mixture of dimethyl benzyl ammonium chloride or dimethyl ethybenzyl ammonium chloride. In some embodiments, the fire retardant or anti-slipping agent is a 1:1 mixture of dimethyl benzyl ammonium chloride or dimethyl ethybenzyl ammonium chloride.

In some embodiments, the liquid loading and coating composition further comprises one or more modifying agent. Examples of the fire retardant or anti-slipping agent have been described herein. In some embodiments, the modifying agent comprises a thickening agent, a tackifier, a gum, an absorbent polymers or combinations thereof. In some embodiments, the one or more modifying agents comprise a carboxymethyl cellulose (CMC)-derived polymer and/or a hierarchically porous carbons (HPC)-derived polymer.

In some embodiments, the one or more modifying agents further comprise one or more additives selected from the group comprising denaturing agents, colorant agents, odor correctors, and/or pH regulators.

In some embodiments, the one or more modifying agents constitute 0.1 to 5% (w/w), 0.1 to 2% (w/w), 0.1 to 1% (w/w), 0.1 to 0.3% (w/w), 0.3 to 5% (w/w), 0.3 to 2% (w/w), 0.3 to 1% (w/w), 1 to 5% (w/w), 1 to 2% (w/w) or 2 to 5% (w/w) of the liquid loading and coating composition.

In some embodiments, the liquid loading and coating composition has a loading and coating capability in the range of 10-50% by volume, 15-45% by volume, 20-40% by volume, 25-35% by volume, or 25-30% by volume. In other embodiments, the liquid loading and coating composition has a loading and coating capability of 100-400% by mass addition, 150-350% by mass addition, or 200-300% by mass addition. In some embodiments, the liquid loading and coating composition of the present application is capable of absorbing liquid at a loading and coating of 25-30% by volume or 200-300% by mass addition.

### Method of Use

Another aspect of the present application relates to a method of using the liquid loading and coating composition of the present application. The method comprises the steps of applying an effective amount of the liquid loading and coating composition of the present application to a surface in need of anti-slipping, and remove the liquid loading and coating composition after a period of time.

In some embodiments, the period of time is from 30 seconds to 30 minutes. In some embodiments, the period of time is from 1 to 30 minutes, from 1 to 20 minutes, from 1 to 10 minutes, from 2 to 30 minutes, from 2 to 20 minutes, from 2 to 10 minutes, from 5 to 30 minutes, from 5 to 20 minutes and from 5 to 10 minutes.

In some embodiments, the surface in need of anti-slipping comprises a biohazard spill. In some embodiments, the biohazard spill is vomit, urine, blood, feces, and/or grease. In some embodiments, the surface in need of anti-slipping is a surface in a public area and needs to be treated to prevent or reduce injuries to users. As used herein, the term “public area” includes, but is not limited to, hospitals, doctors' offices, urgent care facilities, nursing homes, prisons and related correction facilities, schools, buses, aircraft, airports, bars, restaurants, hotels, amusement parks, any large gathering institution facilities, veterinary facilities and drug research and development facilities. In some embodiments, the public area is located in a hotel.

In some embodiments, the method further comprises the step of: washing the treated surface with a liquid or wiping the surface with a wiping material, such as paper tower or mops, after the removal of the liquid loading and coating composition.

Another aspect of the present application relates to a method of blanketing an affected area to prevent or reduce slipping or spread of flame. The method comprises the steps of apply an effective amount of the liquid loading and coating composition of the present application to the affected area and remove the liquid loading and coating composition after a period of time, wherein the liquid loading and coating composition contains a granular absorbent material coated with a static, surface bonded film of fire retardant agent selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604. In some embodiments, the fire retardant/anti-slipping agent is added to the liquid loading and coating composition immediately prior to the application to the affected area.

In some embodiments, the liquid loading and coating composition of the present application is a multi-phase product that can be used to retard flame, anti-slip, or fertilize through a number of different mechanisms. In one embodiment, the composition is a doped granular ceramic agent which combines a surface area static agent or fire retardant or anti-slipping agent coating with a chemical phase primary agent or fire retardant or anti-slipping agent absorbed in the ceramic particles. As used herein, the term “agent” describes the composition and formulations described herein for fire retardation, anti-slipping or fertilizing.

In some embodiments, the liquid loading and coating composition of the present application is a surface area solid phase agent that combines with a super absorbent polymer so that loading and coatings (e.g., 25-30% by volume/200-300% by mass addition) of available liquid can be added so as to impart chemical fire retardation/anti-slipping/fertilizing, to impart deodorizing chemicals or to impart a blanketing effect on the affected area so as to reduce the spread of flame or grease into the environment.

In some embodiments, the liquid loading and coating composition of the present application is a high surface area solid phase agent with the addition of tackifiers, so that it lays on a bio hazard and forms a blanket which greatly reduces the spread of flame or grease into the environment.

The following examples are offered by way of illustration of certain embodiments of aspects of the application herein. None of the examples should be considered limiting on the scope of the application.

### Kits

Another aspect of the present application relates to an anti-slipping kit. The kit can be used for anti-slipping against hazardous materials, such as vomit, urine, blood, feces, and/or a spill of oil or grease. In some embodiments, the kit contains the liquid loading and coating composition of the present application and instructions on how to use the liquid loading and coating composition.

In some embodiments, the kit further contains a copy of OSHA guidelines. In some embodiments, the kit further contains one or more of the following: biohazard bags, gloves, twist tie, antimicrobial hand wipe, germicidal wipe, scoop/scraper.

The anti-slipping kit can be conveniently placed in locations within quick reach of all caregivers. For example; all patient and chemotherapy rooms, case & crash carts, emergency vehicles, cafeteria, environmental services closets, and within or near first aid kits, etc.

In certain embodiments, the application discloses a specialized coating method of a non-toxic bio static film on a high surface area solid, such as a granular absorbent material.

The following examples serve to illustrate certain embodiments of the invention and are not limiting.

### Example 1—Anti-Slipping/Spill Agents

In certain embodiments, this application discloses a method for anti-slipping, comprising the steps of: applying an effective amount of the liquid loading and coating composition described herein in powder form to an exposed surface, wherein the exposed surface is under a layer of grease.

In certain embodiments, this application discloses a method of anti-greasing, comprising the steps of: applying an effective amount of the liquid loading and coating composition described herein in powder form to grease, wherein said grease is absorbed by the liquid loading and coating composition.

In certain embodiments, the liquid loading and coating compositions described herein are a dry phase hydrophobic ceramic absorbent that will remove grease and oil from hard surfaces without the use of water. The perlite is super-heated and vaporized with a Food Contact approved silane. This makes the ceramic mineral permanently hydrophobic. The ceramic mineral will absorb oil only (no water). Silane quaternary compounds can be coated and/or absorbed by the composition. The hydrophobic liquid loading and coating composition will not pick-up water, but does extract oil and grease from the water. The liquid loading and coating composition is a risk management tool that quickly removes grease and reduces liability for slips and falls.

In certain embodiments, an anti-slipping method, comprising the step of: applying an effective amount of the liquid loading and coating composition which comprises a granular absorbent material coated with an anti-slipping agent; and an anti-slipping agent absorbed in said granular absorbent material to a surface in need of anti-slipping; and removing the liquid loading and coating composition after a period of time.

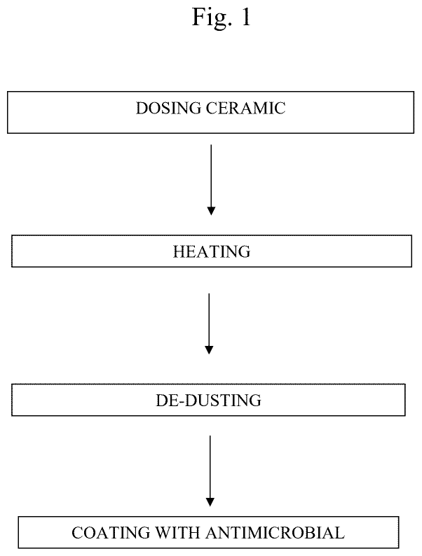

In one exemplary embodiment of the method for creating an anti-slipping agent herein (see FIG. 1): load 500 pounds Perlite into stainless vat or auger. Use 3 grade perlite @150 to 400 microns (or also referred to as 40 to 100 mesh). 1. Dosing: While mixing (tumbling) perlite, mist apply 1-8% by weight Food Grade FDA cleared silane or siloxane water repellant. Mix for 5-10 minutes. 2. Heating: Turn vat heat on to reach 400 to 500 F and continue mixing for 5-10 minutes. 3. De-dusting: 1-3% Rapeseed Oil mist applied during cool down below 150 F and continue mixing for additional 5 minutes. 4. Optional de-dusting for antimicrobial: After Step 3; mist apply 0.1 to 0.50% EPA registered food contact silane quaternary ammonium (e.g., C₂₃H₅₂ClNO₃Si).

Perlite is dosed or vaporized with FDA cleared food contact silane or other hydrophobic coating and super-heated resulting in the only absorbing mineral for oil only (others are polymers). Used as a floor sweep this will by abrasion work into surface and remove oil only when swept away and removed. Not absorbing water allows the product to not “wet out” leaving behind damaging dissolved mineral that will eventually stain a quarry tile floor. The composition herein will sweep through water and remove “slippery oil” from the water. In addition, since it will float on water, it will not plug drains.

In one embodiment, the liquid loading and coating composition is comprised of the doped granular ceramic described herein containing a soft scrubbing exterior with internal chambers that lock in grease and oil. The exterior is wetted with d'limonene (an orange peel extract) which provides natural odor reduction and promotes pest control.

The liquid loading and coating composition is sprinkled over the affected area—swept—and disposed of. The result is an immediate and significant increase of the floor's co-efficient of friction. The process is completed in minutes and provides a quick fix for employee floor safety.

The liquid loading and coating composition's unique water repelling design enables the product to continue moving on the floor when water is present with oil and grease. Otherwise, the absorbent would wet-out and create a mess. However, the liquid loading and coating composition will not only broom from dry to wet but will also remove unwanted oil and grease from the water.

The liquid loading and coating composition is also designed for routine removal of oil and grease “down under” fryers, counters, or other equipment (hot spots for inspectors). Significant labor savings, reduced liability, and clean results are achieved.

The liquid loading and coating composition when applied on fats, oils, and grease will lock and contain the source and hydrocarbons. It can be disposed in landfills, where it is considered non-leaching based on typical anti-slipping procedures.

In an exemplary embodiment, a test for coefficient of friction provides the following data (Coefficient of friction of 0.5 or above is considered to provide nonhazardous walkway surfaces).

| | Coefficient of Friction (COF) | | | |
|---|---|---|---|---|
| | Recorded By American Slip Meter 825 | | | |
| Location At/ | Before | After | Before | After |
| Dishwasher | 0.33 | 0.51 | 0.4 | 0.55 |
| Backdoor | 0.41 | 0.52 | 0.45 | 0.55 |
| Kitchen | | | | |
| Store | 0.55 | 0.65 | 0.59 | 0.64 |
| Entrance | | | | |
| Men's | 0.48 | 0.55 | 0.51 | 0.57 |
| Bathroom | | | | |

Before: mopped and dried and floor pull for COF
After: immediately after first pull applying composition herein, brushing, removal of composition herein, and the another pull for new improved COF

In certain embodiments, the liquid loading and coating compositions described herein are a liquid loaded cleaner/fuel neutralizer for concrete to remove oil stains plus pick up and neutralize fuel spills. In certain embodiments, the composition is expanded absorbing zeolite mineral with accelerated oil only absorption. The absorbing mineral under-goes an exclusive non-toxic process as described herein resulting in hydrophobicity (water repelling). In short, rocks that float and absorb oil. Highest mineral absorbency rate is for oil only. In an exemplary embodiment, one-pound absorbent removes four pounds of oil. Absorbent that inadvertently goes down a floor drain will float to the separator and not plug the drain.

### Example 2—Flame Retardants

A flame retardant suppresses or stops the combustion process. Fire retardants are substances that reduce the flammability or delay the combustion of another material, typically referred to as a fuel. Flame retardants interfere in the pyrolysis of a polymer depending on the flame retardant used and what is being burned. Flame retardants can either be active or reactive. An active flame retardant is blended into a polymer and a reactive flame retardant is inserted into the polymer molecule. The term “flame retardant” refers to a function, not a family of chemicals. A variety of different chemistries, with different properties and molecular structures, act as flame retardants, and these chemicals are often combined for effectiveness. In general, flame retardants are grouped based on whether they contain bromine, chlorine, phosphorus, nitrogen, metals, or boron. In this specification, the terms flame retardant and fire retardant are used interchangeably.

In certain embodiments, a method for flame retardation, comprising the steps of: applying an effective amount of the liquid loading and coating composition described herein in powder form to an exposed flame.

The liquid loading and coating compositions herein are loaded with flame retardants. Active and reactive flame retardants suppress the ignition in the gaseous state of fire and in the solid state. The common process include endothermic degradation, gas phase radical quenching and thermal shielding. Endothermic degradation is mineral compounds such as aluminum and magnesium hydroxides are well known as antacids but they can also be used as flame retardants. These plastic additives break down endothermically when subjected to high heat. This process removes heat from the plastic and cools the material. While high processing temperatures for plastics and relatively low decomposition temperatures for hydroxides and hydrates can limit their use. Mineral flame retardants are usually additive and include boron compounds, antimony oxides, huntite, hydromagnesite and zinc oxides. Gas Phase Radical Quenching is the most common flame retardant plastic additives are brominated flame retardants (BRFs). Brominated flame retardants are organohalogen compounds. Chlorinated and brominated compounds undergo thermal degradation releasing hydrogen chloride and hydrogen bromide. These react with H and OH radicals in the flame producing chlorine and bromine radicals. As the halogen radicals are less reactive than H or OH radicals, they retard the oxidation reactions of the flame. Halogenated flame retardants are low in cost and work on a wide variety of polymers. Thermal Shielding: Phosphorus flame retardants, which include phosphate-ester compounds, are non-halogenated compounds that act on the solid state of combustible materials. Phosphorus forms phosphoric acid when heated which chars the solid forming a thick glassy layer of carbon. This charring prohibits pyrolysis and thus less fuel is available for the fire. Phosphorous flame retardant plastic additives can be additive or reactive. The halogen acts on the gas phase of a fire and the phosphorus inhibits fire in the sold state.

In certain embodiments, the flame retardants are: (1) Chlorinated (CFRs) and Brominated Flame Retardants (BFRs): Chlorine and bromine are examples of halogenated flame retardants. Halogenated flame retardants have one carbon atom bound to a halogen atom and are used to protect many types of plastics and textiles. Applications of CFRs and BFRs are: printed wiring boards, connectors, wire and cable, electronic enclosures, flowing, roofing, insulation foam, plastic wood composites, furniture, and textiles. (2) Phosphorus flame retardants (PFRs): Phosphorus is used to produce liquid and solid organic or inorganic flame retardants. Applications of PFRs are: home furnishing and upholstery, transportation seating, wall sheathing, roofing, refrigeration, and electronic enclosures. (3) Nitrogen-based flame retardants (NFRs): Inorganic flame retardants and mineral compounds: (4) Various inorganic and mineral compounds are combined with bromine, phosphorus or nitrogen and used as flame retardants or as elements of flame retardant systems. The inorganic compounds include those based on nitrogen, graphite, silica, and inorganic phosphates such as ammonium phosphate and polyphosphate. Mineral compounds include certain phosphates, metal oxides, hydroxides, and other metal products such as aluminum, zinc and magnesium.

Phosphoric acid and its salts have been used for a long time as flame retardants. The phosphorous-based salts can be used on their own or in combination with other fire retardants. These include inorganic boron compounds, where boric acid and water soluble sodium tetraborate (borax) are useful, and nitrogen compounds such as urea and guanidine.

Halogenated flame retardants that are used in conjunction with the liquid loading and coating compositions herein include: Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604.

In a particular embodiment, a doped granular ceramic composition described herein combines a flame retardant coating with a chemical phase primary flame retardant absorbed in the ceramic particles.

In one embodiment, the liquid loading and coating compositions are used with a red phosphorus flame retardant. Red Phosphorus is used for one of the allotropic forms of phosphorus. It is obtained by heating white phosphorus at a temperature close to 300 degrees C. in the absence of Oxygen. The color ranges from the orange to the dark violating depending on, molecular weight, particle size, and the impurities. Red Phosphorus is an amorphous inorganic polymer. It is well known the red phosphorus is active as a single additive in nitrogen and/or oxygen containing polymers such as: polyamides, polyesters, polycarbonates, ethylene-vinyl acetate, polyurethanes, epoxies, melamine formaldehyde, polyisocyanates, cellulose and cotton. While it has to be applied with spumific and carbonific agents and/or with inorganic hydroxides in polyolefins, styrenics, rubbers, a.s.o. P-red is the most concentrate source of phosphorus. Therefore, it is an effective flame retardant additive at a concentration ranging from 2% to 10% w based on polymer. Red phosphorus flame retardants are generally applied for meeting high demanding flammability requirements. They do not form toxic smokes. Red phosphorus flame retardants show good electrical and mechanical characteristics.

In one embodiment, the liquid loading and coating compositions are used with a melamine flame retardant. Applications of melamine flame retardants include flexible polyurethane foams, intumescent coatings, polyamides and thermoplastic polyurethanes. Flame retardants function by interference with one of the three components that initiate and/or support combustion: heat fuel and oxygen. Melamine interferes with the combustion process in all stages and in different ways. In the initial stage melamine can retard ignition by causing a heat sink through endothermic dissociation. Another, heat sink effect is generated by the subsequent decomposition of the melamine vapors. Melamine is a poor fuel having a heat of combustion of only 40% of that of hydrocarbons. Furthermore, the nitrogen produced by combustion will act as inert diluent. Another source of inert diluent is the ammonia which is released during breakdown of the melamine or self-condensation of the melamine fraction which does not sublimate. Melamine can also show considerable contribution to the formation of a char layer in the intumescent process. The char layer acts as a barrier between oxygen and polymeric decomposition gases. Char stability is enhanced by multi-ring structures like melem and melon, formed during self-condensation of melamine. In combination with phosphorous synergists melamine can further increase char stability through formation nitrogen-phosphorous substances. Finally melamine can act as blowing agent for the char, enhancing the heat barrier functionality of the char layer.

In one embodiment, the liquid loading and coating compositions are used with a metal hydroxide flame retardant. Metal hydroxides are the most commonly used family of halogen free flame retardants. The mineral compounds are used in polyolefins, TPE, PVC, rubbers, thermosets and can also be used in some engineering polymers (such as polyamide). The use of metal hydroxide flame retardant formulations that meet appropriate standard for many applications. Such formulations produce combustion products for a low opacity, low toxicity, and minimal corrosivity. When properly compounded, inorganic hydroxides offer a cost-effective means to achieve low-smoke flame retardant formulations. In addition, inorganic hydroxides are easily handled and relatively non-toxic. Aluminium trihydroxide (ATH), Magnesium dihydroxide (MDH) and a variety of other inorganic hydroxides are replacing halogenated and phosphorus-containing flame-retardants due to their long-term effects on the environment. Aluminium Trihydroxide (ATH): is used as flame retardant in elastomers, thermosetting resins, and thermoplastics that are processed below 200° C. Magnesium Hydroxide (MH): is a more thermally stable inorganic flame retardant. It is stable to temperatures above 300° C. and finds use in many elastomers and resins, including engineering plastics and other resins that are processed at higher temperatures.

In one embodiment, the liquid loading and coating compositions are used with nanomaterial flame retardants. Expandable graphite provides good flame retardancy properties at low loading and can be used in thermoplastic resins and thermosetting resins. For natural charring polymer (PA, PU, PVC . . . ), expandable graphite can be successful used alone. Nanoclays reduce relative heat release, promote surface char, create an anti-dripping effect, and reduce smoke generation. Multi-walled carbon nanotubes (CNTs) are used commercially for their electrostatic dissipative (ESD), strength properties and flame retardant properties. They are: Effective at forming char, Retard onset of combustion by drawing heat away, Increase viscosity to help prevent dripping, and Do not contribute to depolymerization. CNTs are expected to find use in electronics, where they can provide both ESD and flame retardant properties. Polymer-clay nanocomposites are hybrid organic polymer inorganic layered materials with unique flammability properties when compared to conventional filled polymers. Polyamide-6, polystyrene and polypropylene are some polymers used in combination with clays.

In one embodiment, the composition herein works to extinguish a fire and prevent re-ignition by eliminating each of the three sides of the fire triangle: Heat, Oxygen, and Fuel. First, the wetting power of the composition herein rapidly cools and penetrates (Removing Heat). Second, the composition herein works to encapsulate and blanket the oxygen at the surface of the fire (Removing Oxygen). Last, the composition herein prevents re-ignition by breaking the hydrocarbon strings and suppressing flammable vapor helping to render the fuel source inert (Removing Fuel).

In one embodiment, the composition herein is an aqueous synthetic bio-surfactant that functions as a wetting agent or form. The composition herein concentrate is intended for use on Class A (ordinary combustibles such as wood, paper, etc. . . . ) and Class B (flammable liquids such as gasoline, diesel fuel, oil, kerosene, etc. . . . ) polar and nonpolar fuel fires. The composition herein replaces foams, halon, and other conventional chemicals.

It can be used with both aspirating and non-aspirating discharge devices due to the low energy required to make it foam. The excellent wetting characteristics make it useful in combating Class A fires. It can be used with dry chemical suppressing agents without the need to be concerned with the order of application, which allows for greater fire protection capability and flexibility. When used with fresh or salt water, at the correct dilution, with most conventional foam making equipment, the expansion ratio will vary depending on the performance characteristics of the equipment. Aspirating discharge devices produce expansion ratios from 6:1 to 10:1 depending primarily on type of aspirating device and flow rate. Non-aspirating devices such as handline water fog/stream nozzles or standard sprinkler heads produce expansion ratios of 2:1 to 6:1. The composition herein concentrate can be easily proportioned (at the correct dilution) using most conventional proportioning equipment such as: 1. Balanced pressure and in-line balanced pressure pumped proportioning equipment 2. Balanced pressure bladder tank proportioners 3. Around-the-pump type proportioners 4. Fixed or portable (in-line) venturi type proportioners 5. Handline nozzles with fixed induction/pickup tubes The usable temperature range for the composition herein concentrate with this equipment is 35° F. to 120° F. (2° C. to 49° C.).

The composition herein can be used to create fire breaks by simply applying the chemical to the material in question. The composition herein will penetrate and protect treated materials such as adjacent structures, interior walls, grass covered areas, trees, cars, etc. It will remain effective as a retardant as long as the treated object remains wet or in the case of porous Class A materials for a period of up to several weeks. In certain extreme situations, the composition herein may even be sprayed directly onto personnel and victims to aid in evacuation and rescue. When used as directed, the composition herein is up to six times more effective than water alone. This provides several benefits to the user including a substantial reduction in water usage. This can be a critical advantage when fighting fires in remote areas with limited water availability. Further, since in many cases the majority of damage caused in a fire is caused by water, a reduction in its use means less damage to the property owner. The composition herein chemically encapsulates the toxic smoke produced by a fire thus reducing the hazards posed by smoke inhalation and flashover. Hydrocarbon gases and fine materials held in the smoke are knocked out of the air by the product and encapsulated. Typically, the smoke will change color from a dark black smoke filled with unburned hydrocarbons and gases to a “clean” white smoke void of any of this material.

When using the composition herein to extinguish class A fires, it is best applied using an air aspirating type nozzle; the composition should be applied at a 1% solution mixed with water (i.e. 1 parts the composition herein to 99 parts water). When applying the composition herein to class B fires, the product should be applied at a 3% solution mixed with water (i.e. 3 parts the composition herein to 97 parts water) using an aspirating nozzle. To apply the composition herein to a class D fire (i.e. flammable metals such as magnesium, titanium, phosphorous, and aluminum) the product should be mixed with water at a 5% solution (i.e. 10 parts composition herein to 95 parts water). This solution should be applied to the fire using an air aspirating nozzle. When using the composition herein on fires containing multiple classes of materials such as class A, B, and D materials, a 3% solution of composition herein and water is recommended (i.e. 3 parts composition herein and 97 parts water).

The flame retardant and anti-slipping agent embodiments herein may be combined by adding flame retardant as a coating to the anti-slipping agent. Travel plazas, convenience stores, restaurants, and virtually all facilities that have to contend with removing oil, grease, and all types of liquids from their lots (outdoor parking spaces, fuel islands, fast food drive-thru's, greasy backdoors, and dumpster areas, etc) may all be locations where the flame retardant, anti-slipping agent, or both may be required at times. The flame retardant or anti-slipping agents described herein resolve outdoor spot cleaning issues as follows: 1) Labor is potentially cut in half (for spot cleaning) 2) the flame retardant/anti-slipping agent is removed therefore no EPA Storm Water violations can occur 3) the flame retardant/anti-slipping agent is neutral (will not burn skin) and actually increases the co-efficient of friction 4) the flame retardant/anti-slipping agent ceramic chambers lock in contaminates and produces little to no tracking 5) Consumer perception of cleanliness is quickly resolved even in winter months 6) the flame retardant/anti-slipping agent can be implemented into EPA Storm Water best management plans. The flame retardant/anti-slipping agent physically removes the topical oil, grease, or liquid from concrete or asphalt. The product is then picked up and normally disposed of as trash (follow all regulations). Any left behind residual will leave the surface even cleaner after rainfall.

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The above description is for the purpose of teaching the person of ordinary skill in the art how to practice the object of the present application, and it is not intended to detail all those obvious modifications and variations of it which will become apparent to the skilled worker upon reading the description. It is intended, however, that all such obvious modifications and variations be included within the scope of the present application, which is defined by the following claims. The aspects and embodiments are intended to cover the components and steps in any sequence, which is effective to meet the objectives there intended, unless the context specifically indicates the contrary.

What is claimed is:

1. A method of formulating a liquid loading and coating composition for anti-slipping, comprising the steps of:
coating a granular absorbent material with a coating agent to produce a coated absorbent material,
wherein the coating agent is cleared silane or siloxane water repellant;
wherein the coating agent forms a surface bonded film on the granular absorbent material, and
wherein the granular absorbent material is selected from the group consisting of ceramic minerals, perlite, zeolite, activated carbon, fumed silica, processed clays, cellulosic absorbents, fibrous absorbents and combinations thereof, and
superheating and continued mixing of the granular absorbent material with the coating agent to form a coated absorbent material;
mixing the coated absorbent material with an absorbable agent,
wherein the absorbable agent is rapeseed oil;
wherein the coated absorbent material absorbs the absorbable agent to form the composition,
wherein the absorbable agent is a liquid.

2. The method of claim 1, wherein the absorbable agent is rapeseed oil.

3. The method of claim 1, wherein the composition is hydrophobic.

4. The method of claim 1, wherein the granular absorbent material is perlite.

5. The method of claim 4, wherein the perlite has been superheated at 400 to 500 F.

6. A method for anti-slipping, comprising the steps of: applying in powder form to an exposed surface an effective amount of a liquid loading and coating composition comprising:
a granular absorbent material coated with a coating agent,
wherein the coating agent forms a surface bonded film on the granular absorbent material,
wherein the coating agent is cleared silane or siloxane water repellant, and
wherein the granular absorbent material is selected from one of the group consisting of ceramic minerals, perlite, zeolite, activated carbon, fumed silica, processed clays, cellulosic absorbents, fibrous absorbents and combinations thereof,
wherein the granular absorbent agent has been super-heated; and
an absorbable agent absorbed in said granular absorbent material.

7. The method of claim 6, wherein the exposed surface is located within a vehicle.

8. The method of claim 6, wherein the exposed surface is located within an interior of a building.

9. A method for flame retardation, comprising the steps of: applying in powder form to an exposed flame an effective amount of a liquid loading and coating composition comprising:
a granular absorbent material coated with a coating agent,
wherein the coating agent forms a surface bonded film on the granular absorbent material,
wherein the coating agent is selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof, and
wherein the granular absorbent material is selected from the group consisting of ceramic minerals, perlite, zeolite, activated carbon, fumed silica, processed clays, cellulosic absorbents, fibrous absorbents and combinations thereof, and
an absorbable agent absorbed in said granular absorbent material,
wherein the absorbable agent is selected from one or more of the group consisting of surfactants, anionic surfactants, inorganic salts, ferrocene and fluorinated surfactants, and combinations thereof.

10. The method of claim 9, wherein the exposed flame is within an interior of a building.

11. A liquid loading and coating composition for anti-slipping, comprising:
a granular absorbent material coated with a coating agent,
wherein the coating agent forms a surface bonded film on the granular absorbent material,
wherein the coating agent is cleared silane or siloxane water repellant, and
wherein the granular absorbent material is selected from one of the group consisting of ceramic minerals, perlite, zeolite, activated carbon, fumed silica, processed clays, cellulosic absorbents, fibrous absorbents and combinations thereof,
wherein the granular absorbent agent has been super-heated; and
an absorbable agent absorbed in said granular absorbent material.

12. The liquid loading and coating composition of claim 11, wherein the absorbable agent is rapeseed oil.

13. The liquid loading and coating composition of claim 11, wherein the composition is hydrophobic.

14. The liquid loading and coating composition of claim 11, wherein the granular absorbent material is perlite.

15. The liquid loading and coating composition of claim 14, wherein the perlite has been superheated at 400 to 500 F.

16. A liquid loading and coating composition for flame retardation, comprising:
a granular absorbent material coated with a coating agent,
wherein the coating agent forms a surface bonded film on the granular absorbent material,
wherein the coating agent is selected from the group consisting of Hexabromobenzene (HBB), Pentabromoethylbenzene (PBEB), Tetrabromoethylcyclohexane (TBECH), 1,2,5,6-Tetrabromocyclooctane (TBCO), 2-Bromoallyl 2,4,6-tribromophenyl ether (BATE), Allyl 2,4,6-tribromophenyl ether (ATE), 2,3-Dibromopropyl 2,4,6-tribromophenyl ether (DPTE), 2,2′,3,3′,4,5,5′,6,6′-Nonabromo-4′-chlorodiphenyl ether (4 PC-BDE208), 2,2′,4,4′,5,5′-Hexabromobiphenyl (BB-153), Hexabromocyclododecane (HBCD), Hexachlorocyclopentadienyl-dibromocyclooctane (HCDBCO), Decabromodiphenylethane (DBDPE), 1,2-bis(2,4,6-Tribromophenoxy)ethane (BTBPE), Octabromotrimethylphenylindane (OBIND), 2-Ethylhexyl-2,3,4,5-tetrabromobenzoate (EHTeBB), Bis(2-ethyl-1-hexyl)tetrabromophthalate (BEHTBP), Dechlorane plus (DP), Dechlorane 602, and Dechlorane 604 and combinations thereof, and
wherein the granular absorbent material is selected from the group consisting of ceramic minerals, perlite, zeolite, activated carbon, fumed silica, processed clays, cellulosic absorbents, fibrous absorbents and combinations thereof, and
an absorbable agent absorbed in said granular absorbent material,
wherein the absorbable agent is selected from one or more of the group consisting of surfactants, anionic surfactants, inorganic salts, ferrocene and fluorinated surfactants, and combinations thereof.

17. The liquid loading and coating composition of claim 16, wherein the granular absorbent material comprises ceramic minerals.

18. The liquid loading and coating composition of claim 16, wherein the ceramic minerals comprise perlite and/or vermiculite.

19. The liquid loading and coating composition of claim 16, wherein the coating agent is Hexabromobenzene (HBB).

20. The liquid loading and coating composition of claim 16, wherein the absorbable agent is soap.
